(19) United States
(12) Patent Application Publication
(10) Pub. No.: US 2024/0341277 A1
(43) Pub. Date: Oct. 17, 2024

(54) SCRATCHING APPARATUS

(71) Applicant: HEBE STUDIO LIMITED, Oxfordshire (GB)

(72) Inventors: James TUTHILL, Oxfordshire (GB); Johannes PAUL, London (GB); Simon NICHOLLS, Northamptonshire (GB); William WINDHAM, Oxfordshire (GB)

(21) Appl. No.: 18/682,981

(22) PCT Filed: Aug. 11, 2022
(86) PCT No.: PCT/EP2022/072498

§ 371 Date: Feb. 12, 2024

(30) Foreign Application Priority Data
Aug. 11, 2021 (GB) 2111562.1

(51) Int. Cl. A01K 15/02

(52) U.S. Cl. CPC A01K 15/024

(57) ABSTRACT

Scratching apparatus comprising a support 11 for a scratchable cover 5, the support defining an internal cavity and having an outer face 211 against which said cover lies when the cover is mounted on the support, said outer face having a recess 213 formed therein in which a plurality of lights 250, 207, 209 is provided, the lights being coupled to a lighting controller 227 provided in said internal cavity, said controller 227 being operable to illuminate one or more of said lights.

### FIELD

This disclosure relates to scratching apparatus, also colloquially known as scratching posts, particularly but not exclusively to scratching apparatus for felines such as domestic cats.

### BACKGROUND

It is well known that felines such as domestic cats have a natural urge to scratch their claws against rough surfaces. The act of scratching is thought to de-stress cats and make them calmer, as well as having other benefits such as removing old material from their claws and enabling them to mark their territory.

As many cat owners will attest, cats often choose items of furniture such as sofas and table or chair legs to scratch their claws against, and in an attempt to discourage such behaviour many owners purchase scratching apparatus, more usually known as scratching posts. A typical example of a previously proposed scratching post is the “Trixie Parla” 62 cm scratching post sold by Amazon.co.uk. This post comprises a generally rectangular covered base, and a post upstanding from the base that has a sisal rope wound around its' peripheral surface.

Whilst such posts can be effective in encouraging cats to scratch against the post instead of an item of furniture, it is the case that the action of the cat scratching on the sisal rope damages the rope over time and makes the post as a whole less effective. If this should happen, the only recourse for the user is to purchase a new scratching post, which is expensive and unnecessarily wasteful.

To address this, it has previously been proposed, in United States Patent Application number 2002/0195064, for example, to provide scratching apparatus that comprises a base and upstanding post, as per conventional scratching posts, and a removable and hence replaceable scratchable cover that is attached to the post by means of a hook-and-loop fixing system such as Velcro™.

Whilst these previously proposed posts provide useful alternatives to furniture legs, it remains the case that some cats can become bored with scratching against the post and revert to scratching against the furniture.

To address this, it has previously been proposed, in Chinese Utility Model No. 206674779 for example, to mount a series of lights beneath the outer sisal covering of the scratching post, which lights can be flashed on and off to attract the cat and maintain the cat's interest in the scratching post. Whilst this arrangement does help to retain the cat's interest in the scratching post, the sisal cover is not replaceable and as such the entire post needs to be thrown away and replaced when the sisal is worn.

Another previously proposed scratching post is described in U.S. Pat. No. 9,491,928. In this instance the scratching post comprises a central support around which a string of lights is wound, and a light-transmissive substrate within which the central support and lights are encased. A light-transmissive cover is applied to the outside of the substrate, against which a pet can scratch their claws. The lights can be energised to illuminate the substrate within which they are encased, and the light can escape through the cover. However, encasing the strip of lights within the substrate increases the distance between the lights and the cover and inevitably provides a more diffuse form of lighting that is more suited to mood lighting, than forming a spot of light on the cover for a cat to chase.

Another way of maintaining a cat's interest in a scratching post, is to use “catnip”. Catnip is a plant related to mint and contains an essential oil called nepetalactone that is known to cause euphoric, almost hallucinogenic feelings when inhaled by a cat. Catnip is available in a liquid form and can be sprayed onto a scratching post to attract a cat to the post. It has also been previously proposed to provide scratching posts that are infused with catnip oil-see for example the Rosewood Turin Cat Scratching Post available from https://fetch.co.uk/rosewood-turin-cat-scratching-post-413044011.

Whilst such arrangements do attract a cat to the scratching post, at least initially, research has suggested that catnip should be used as a treat for a cat instead of being constantly available, as a constant exposure to catnip can lead to a reduction in the effect that it has on a cat.

Aspects of the scratching apparatus disclosed herein have been devised with at least some of the aforementioned issues in mind.

### SUMMARY

One aspect of this disclosure provides scratching apparatus comprising a support for a scratchable cover, the support defining an internal cavity and having an outer face against which said cover lies when the cover is mounted on the support, said outer face having a recess formed therein in which a plurality of lights is provided, the lights being coupled to a lighting controller provided in said internal cavity, said controller being operable to illuminate one or more of said lights. An advantage of this arrangement is that locating the lights immediately below the scratchable cover increases the amount of light that can pass through the cover. Furthermore, by providing the lights in a recess formed in an outer face of the support, the lights are protected from damage by a user when the scratchable cover is replaced.

The outer face may include a plurality of spaced recesses extending generally in parallel with a longitudinal axis of said support, each recess having a plurality of lights provided therein.

The plurality of lights may be arranged in strips, said strips being affixed to the outer face of said support so that light from the strips can shine through the cover when the cover is received on the support.

The lighting strips may comprise a plurality of modules joined end-to-end, each module including one or more lights. One or more of said recesses may provided with a mirrored finish to increase the amount of light directed towards the cover. The support may comprise a plurality of tabs in the vicinity of each recess that function to retain the strips in the recesses. Each recess may include an access aperture opening to the interior of the support.

The scratching apparatus may comprise a distribution node that is coupled to said controller. The controller and distribution node may be hidden within the interior of the support. The lighting strips may be electrically connectable in parallel to said distribution node.

The lighting strips may be electrically connectable in series to the distribution node. The lighting strips may be coupled to adjacent strips by wires. The scratching apparatus may comprise a retaining clip that is generally C-shaped in lateral cross-section and may be frictionally retained in a said recess, the clip including a tab that lies over the wires to protect the wires as a cover is put onto and taken off the support. The lighting strips and connecting wires may form a serpentine structure.

The lights may be configured so each light can be separately illuminated, and/or so that groups of lights can be separately illuminated.

The scratching apparatus may comprise a user interface that allows a user to instruct the controller to control the lights. The user interface may comprise a button that a user can press to control the controller. The controller may be controllable with a remote commander that can wirelessly communicate with a transceiver in the controller. The controller may comprise a wireless transceiver and is controlled by means of an app on a mobile computing device.

The scratching apparatus may further comprise a dispenser having a nozzle provided within said internal cavity, said support having a dispensing aperture provided in said outer face, said dispenser being arranged within the support cavity so that the nozzle of the dispenser is adjacent the dispensing aperture for the dispense of fluid through the aperture and any cover mounted on said support.

The dispenser may controllable by a user to dispense fluid through the aperture and any cover received on said support.

The support may comprise a plurality of support members, the support being reconfigurable between first and second states, wherein in said first state a scratchable cover supported by said support is loosely mounted on said support and in said second state said scratchable cover is tensioned around the support, the arrangement being such that reconfiguring said support from said first state to said second state causes at least one of said support members to move relative to another support member to tension the scratchable cover around the support, and reconfiguring said support from said second state to said first state causes at least one of said support members to move relative to another support member to loosen the scratchable cover mounted on the support.

The arrangement may be such that reconfiguring said support from said first state to said second state causes at least one of said support members to move relative to another support member to increase the spacing between the support members and thereby tension the scratchable cover on the support. The plurality of support members may be moveably coupled to one another.

The support may comprise first and second support members coupled together in a clamshell arrangement.

Another aspect of the disclosure relates to a scratchable cover configured and arranged for use with scratching apparatus of the type disclosed herein, wherein the scratchable cover comprises a panel having first and second faces, said first face comprising a scratchable surface, said second face including first and second couplings connectable, respectively, to said first and second support members to couple the cover to the support.

A further aspect of the disclosure relates to a scratchable cover configured and arranged for use with the scratching apparatus of the type disclosed herein, wherein the scratchable cover comprises a tubular body sized to fit over said support, said tubular body having an external face and an internal face, said external face comprising a scratchable surface.

In a yet further aspect, there is disclosed scratching apparatus comprising a support for a scratchable cover, the support defining an internal cavity in which a dispenser having a nozzle is provided, the support having an external wall in which a dispensing aperture is provided, said dispenser being arranged within the support cavity so that the nozzle of the dispenser is adjacent the dispensing aperture for the dispense of fluid through the aperture and any cover mounted on said support.

In another aspect there is disclosed scratching apparatus comprising a support for a scratchable cover, the support defining an internal cavity in which a dispenser having a dispensing nozzle is provided, the support having an external wall in which a dispensing aperture is provided, said dispenser being arranged within the support so that the dispensing nozzle of the dispenser is adjacent the dispensing aperture, the dispenser being controllable by a user to dispense fluid through the aperture and any cover received on said support. An advantage of this arrangement, when the dispenser is used for the dispense of catnip, is that a user is more readily able to use catnip as a treat for a cat, by controlling when the cat is exposed to catnip.

In yet another aspect there is disclosed scratching apparatus comprising a support for a scratchable cover, wherein the support comprises a plurality of support members, the support being reconfigurable between first and second states, wherein in said first state a scratchable cover supported by said support is loosely mounted on said support and in said second state said scratchable cover is tensioned around the support, the arrangement being such that reconfiguring said support from said first state to said second state causes at least one of said support members to move relative to another support member to tension the scratchable cover around the support, and reconfiguring said support from said second state to said first state causes at least one of said support members to move relative to another support member to loosen the scratchable cover mounted on the support.

Any aspect disclosed herein may be combined with any one or more of the aspects mentioned above.

Other features and aspects of the apparatus are disclosed below.

### BRIEF DESCRIPTION OF THE DRAWINGS

Various aspects of the teachings of the present invention, and arrangements embodying those teachings, will hereafter be described by way of illustrative example with reference to the accompanying drawings, in which:

FIG. 1 is a schematic perspective view of an illustrative scratching apparatus;

FIG. 2 is a schematic perspective view of a scratchable cover for the apparatus of FIG. 1;

FIG. 3 is a schematic perspective view of a base and expandable support for the apparatus of FIG. 1;

FIG. 4 is a perspective view of an upper side of the base depicted in FIG. 3;

FIG. 5 is a perspective of the underside of the base depicted in FIG. 3;

FIG. 6 is a top perspective view of a portion of the apparatus depicted in FIG. 1;

FIG. 7 is an underneath perspective view of the apparatus depicted in FIG. 6;

FIG. 8 is an exploded perspective view of an expandable support for the apparatus of FIG. 1;

FIG. 9a is an enlarged view of a portion of the support shown in FIG. 8;

FIG. 9b is an enlarged view of another portion of the support shown in FIG. 8;

FIG. 10 is a sectional view along the line A-A of FIG. 3;

FIG. 11 is a sectional view along the line B-B of FIG. 3;

FIGS. 12 and 13 are cross-sectional views along the lines A-A and B-B, respectively, of FIG. 3 showing the support in another configuration;

FIGS. 14 and 15 are part sectional views of the base when coupled to the expandable support;

FIGS. 16a and 16b are schematic depictions of the manner in which a cover of the type shown in FIG. 2 can be removed from a support of the type shown in FIG. 3 and then replaced;

FIG. 17 illustrates how the apparatus depicted in FIG. 16 can be adjusted to expand the support and thereby tension the cover;

FIGS. 18 and 19 are front and rear perspective views of a cover for a second illustrative scratching apparatus;

FIG. 20 is a perspective view of the aforementioned second illustrative scratching apparatus;

FIG. 21 is a perspective view of the apparatus depicted in FIG. 20 shown partly disassembled;

FIGS. 22 to 25 are various top plan views of the apparatus in several different stages of the assembly process;

FIG. 26 is a diagrammatic sectional view of a third illustrative scratching apparatus;

FIG. 27 is a schematic representation of a version of the aforementioned first illustrative scratching apparatus, modified to include a plurality of lights;

FIG. 28 is a schematic representation of one implementation of the scratching post shown in FIG. 27 with the cover removed;

FIGS. 29 and 30 are front and rear view of part of one of the support members of the scratching post of FIG. 27;

FIG. 31 is a schematic representation of another implementation of the scratching post shown in FIG. 27 with the cover removed;

FIG. 32 is a front view of part of one of the support members of the scratching post of FIG. 31;

FIG. 33 is a schematic representation of a version of the aforementioned first illustrative scratching apparatus, modified to include a dispenser for catnip;

FIG. 34 is a perspective view of a dispenser;

FIG. 35 is a diagrammatic view of the components of the dispenser shown in FIG. 34;

FIG. 36 is a schematic representation of the scratching apparatus shown in FIG. 33 with the cover removed, partly cut-away to show the dispenser; and

FIG. 37 is a schematic representation of another scratching apparatus with the scratchable cover removed, partly cut-away to show the dispenser.

### DETAILED DESCRIPTION

Before embarking upon a detailed description of various implementations of the apparatus disclosed herein, it is appropriate to mention that references to orientations (such as “upper”, “lower”, “top” and “bottom”) are intended to refer to the apparatus in normal use, and are not intended to limit the scope of the disclosure—in particular in other circumstances, for example when the apparatus is packaged for sale or transport.

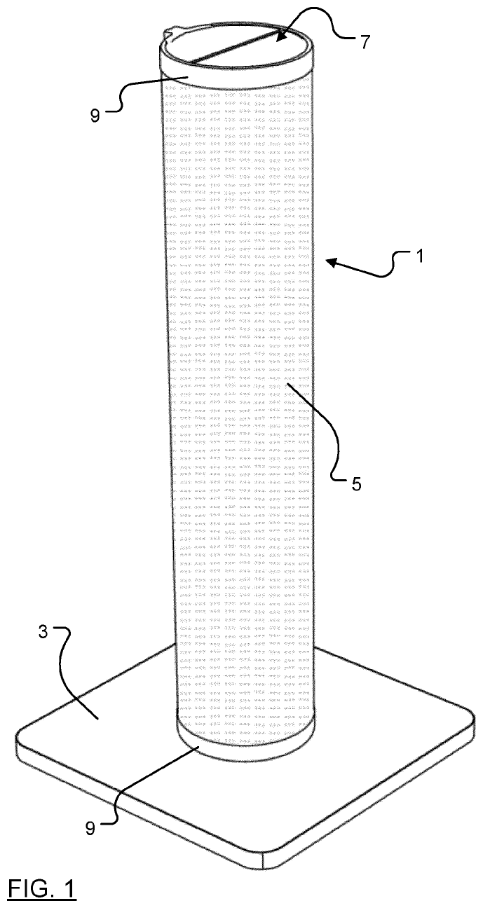

Referring now to FIG. 1 of the accompanying drawings, there is depicted a schematic perspective view of an illustrative scratching apparatus. This apparatus, and other scratching apparatus disclosed herein, is the subject of our co-pending UK patent application no. 2001521.0 and our co-pending PCT patent application PCT/EP2021/052652 (the contents of each of which are incorporated herein by reference).

The scratching apparatus comprises a base 3 to which an expandable support (not visible) has been affixed. A replaceable scratchable cover 5 is mounted upon and tensioned by the support, following which a two-part cap 7 has been fitted to the support to hide the internal workings of the support. In the preferred implementation the base is relatively weighty and significantly larger than the support so that a cat, for example, leaning against the scratchable surface is unlikely to cause the apparatus to topple over.

The scratchable cover 5, in this arrangement, comprises a panel of sisal matting that has been formed into a tube and hemmed 9 at either peripheral end to maintain the tubular shape of the cover. As will be appreciated by persons of skill in the art, the scratchable cover need not comprise sisal matting. The cover could, for example, by of any of a number of alternative scratchable materials, for example a panel of carpet or other rough material against which an animal can scratch their claws.

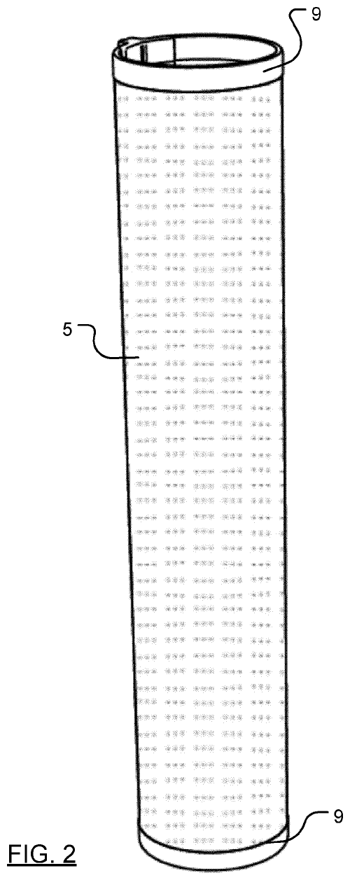

FIG. 2 is a schematic perspective view of the scratchable cover 5 once it has been removed from the apparatus 1 shown in FIG. 1. As aforementioned, the cover 5 in this embodiment comprises a panel of sisal matting that has been formed into a tube, and secured in that configuration by hems 9 at either end of the tube. Adjacent peripheral edges of the panel running between the hems 9 are also joined to one another.

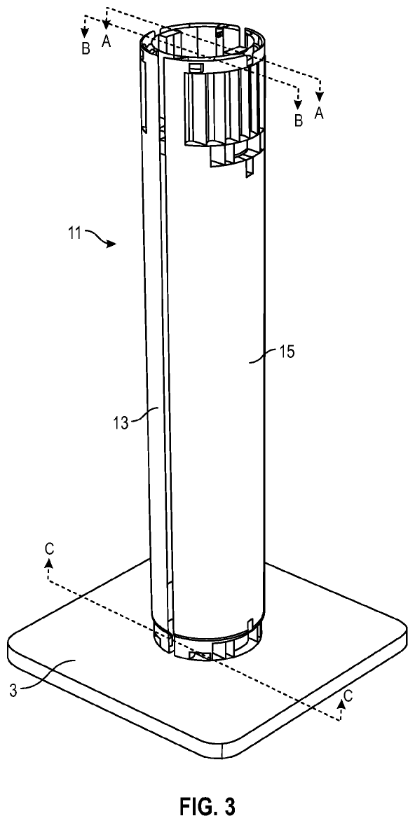

FIG. 3 shows the base 3 and the expandable support 11 of the apparatus, which support 11 is hidden from view in FIG. 1. As shown, the two-part cap 7 has been removed from the support to enable access to be had to the internal components of the support 11.

The support 11 is coupled to the base (in a manner that is later described in detail) so that the respective components of the support can move relative to the base 3 as the support is expanded and contracted. In this particular example, the support comprises two support members 13, 15 that are coupled to one another and to the base in such a manner (which will later be described in detail) that the support members can move relative to one another and the base to increase or reduce the distance between them. In the particular arrangement that is hereafter described, the support is configured so that both support members can move relative to the base. It will be appreciated, however, that equivalent functionality may be achieved by fixing one said support member to the base so that it cannot move, and enabling the other support member to move relative to the fixed support member. Both of these arrangements are intended to be within the scope of the present disclosure.

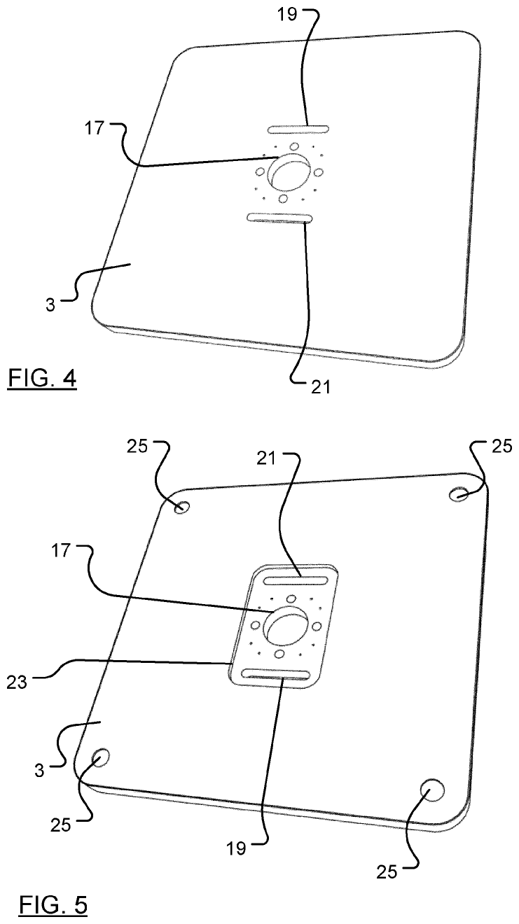

Referring now to FIGS. 4 and 5, there are depicted-respectively-perspective views of an upper side and a lower side of the base 3. The base includes an aperture 17 so that a user can access the internal mechanism of the support 11 (for example to expand or contract the support) without having to decouple the support from the base. The base also includes first and second slots 19, 21 along which fixings (not shown) coupling the support to the base can slide as the support is expanded or contracted.

The underside of the base includes a recess 23 so that the aforementioned fixings are lifted off a surface, for example a floor, on which the scratching apparatus is placed in use and hence are less likely to scratch that surface if the apparatus should move in use. The underside of the base 3, as shown in FIG. 3, includes a plurality of feet 25 that space the underside of the base from a surface on which it is placed. The feet may be of a high-friction material, such as rubber, to lessen the likelihood of the apparatus moving, in use, over the surface of a floor on which it has been placed.

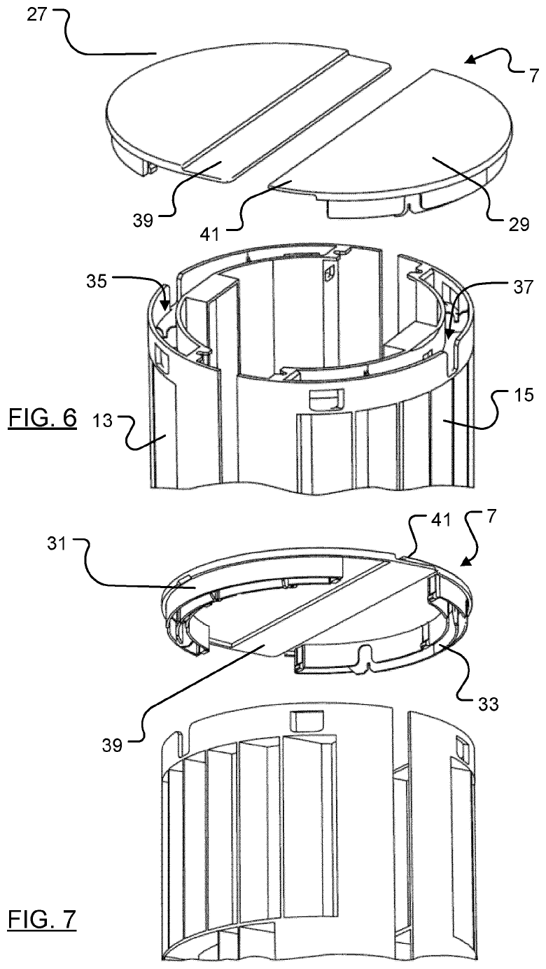

Referring now to FIGS. 6 and 7, there is depicted an upper portion of the support 11 and the two-part cap 7 that fits into the support (as shown in FIG. 1).

The cap 7 comprises first and second generally semi-circular cap portions 27, 29 from each of which arcuate walls 31, 33 extend. The upper peripheral ends of the support members 13, 15 each include a channel 35, 37 that is configured to accommodate respective arcuate walls 31, 33 of the cap portions 27, 29. The walls 31, 33 may simply sit within the channels 35, 37 or may be configured to positively engage, for example snap-fit, into the channels. Adjacent peripheral edges of the cap portions 27, 29 include respective transversely extending ledges 39, 41 that overlap when the two cap portions 27, 29 are brought together as shown in FIG. 7. The cap is configured so that when the support members 13 are closest together the ledge 41 extending from the second cap portion 29 fully overlaps with the ledge 39 extending from the first cap portion 27 (as shown in FIG. 7). As the support is expanded to tension a cover fitted thereto, the support members move apart and the degree of overlap that occurs when the caps are fitted to respective support members lessens. In the preferred arrangement the degree of support expansion permitted is such that the interior of the support is always covered when the cap 7 is fitted thereto.

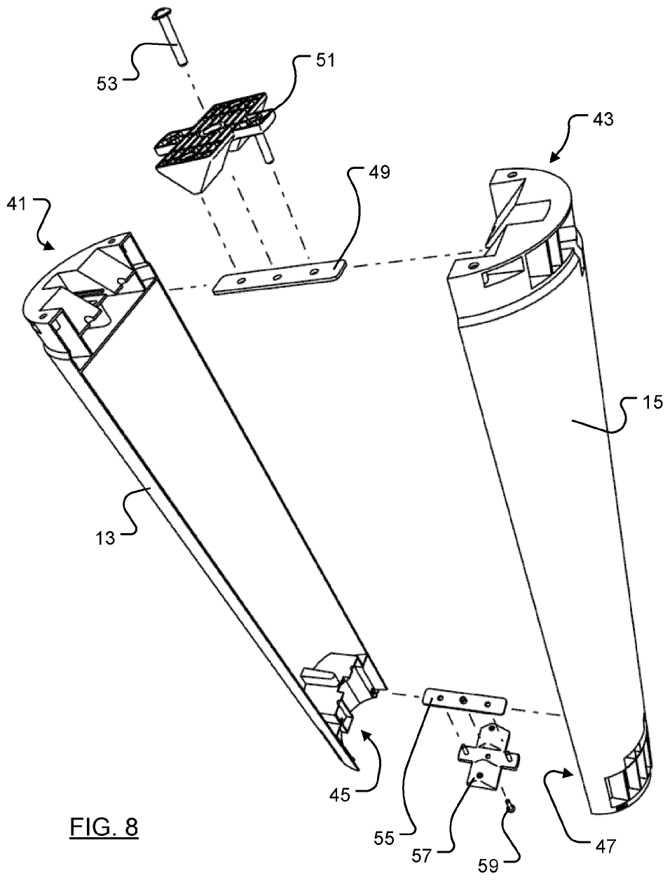

FIG. 8, as aforementioned, is an exploded perspective view of the expandable support. However, in FIG. 8 the support is shown inverted with the “lower” end (i.e. the end that will be adjacent the base when the apparatus is fully assembled) uppermost in the figure, and the “upper” end (i.e. the end to which the cap is fitted when the apparatus is fully assembled) lowermost in the figure.

The support members are coupled together and movable relative to one another to expand or contract the support in the same way using similar structural components in the vicinity of upper and lower ends of the support. Although the coupling formations provided in the vicinity of respective ends of the support differ slightly in form, this does not affect the manner in which they operate and to that end only the coupling formations in the vicinity of the lower end of the support will hereafter be described in detail.

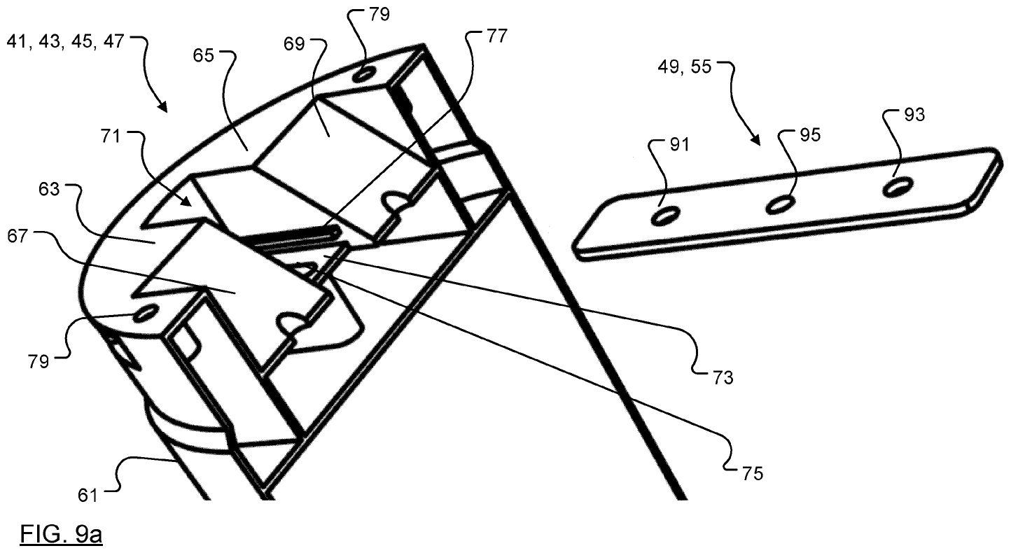

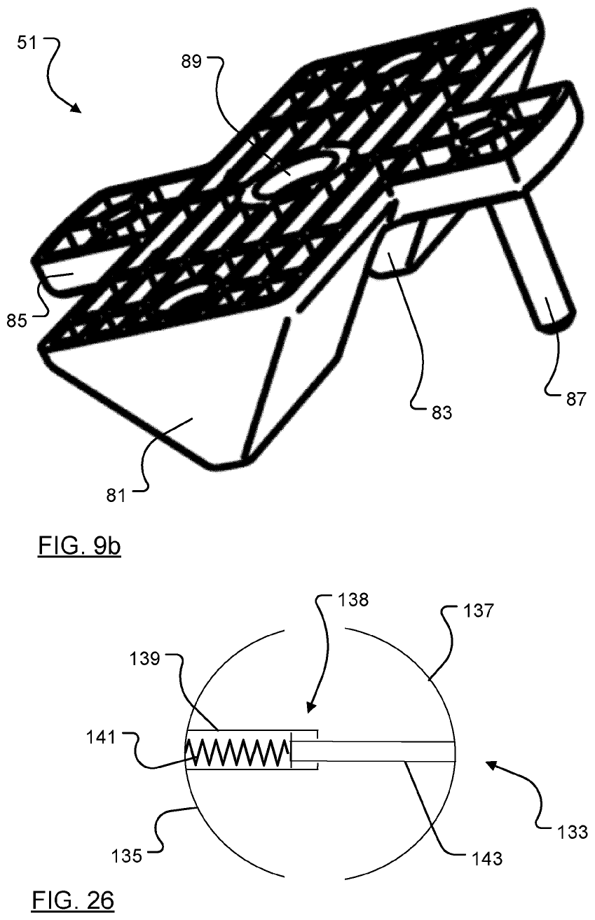

With the foregoing in mind, reference will now be made to FIGS. 8, 9a and 9b, which depict the expandable support and the aforementioned first and second support members 13, 15. The support members 13, 15 each include a lower coupling formation 41, 43 in the vicinity of each lower end, and an upper coupling formation 45, 47 in the vicinity of each upper end (“upper” referring to the end that will be uppermost in use and to which the cap can be fitted, and “lower” referring to the end that will be lowermost in use adjacent the base (when the apparatus is fully assembled)).

Between respective coupling formations each support member is generally semi-circular in transverse cross-section. As aforementioned, the upper coupling formations are functionally identical, albeit slightly structurally different—the chief difference being that the lower coupling formations are at or at least close to the lower ends of the support members (to facilitate coupling to the base) whereas the upper coupling formations are spaced from the upper ends of the support members so as to provide room for coupling the cap to the support.

The lower coupling formations 41, 43 are coupled together by means of a generally rectangular retainer 49, a co-operating lower wedge 51 and a fixing 53. Similarly, the upper coupling formations 45, 47 are coupled together by means of a generally rectangular retainer 55, a co-operating upper wedge 57 and a fixing 59. As aforementioned, the upper and lower coupling formations function in the same manner, and are structurally similar to one another.

As shown in FIG. 9a (where one lower coupling formation is shown, the other lower coupling formation being an identical mirror image), the upper and lower coupling formations each include first and second projections 63, 65 that project inwardly in a direction away from an external peripheral surface 61 of the support member. Each projection 63, 65 terminates in a ramped surface 67, 69 that is inclined away from the base (in the context of the lower coupling formations) or away from the cap (in the context of the upper coupling formations). A channel 71 is provided between the projections, and the channel terminates in a lateral wall 73 that is provided with a slot 75. A pair of ribs 77 (one of which is visible in FIG. 9a) extend from the projections 63, 65 into the channel 71 and are spaced from the lateral wall 73 to leave a space between the ribs and the lateral wall 73, which space is sized to slidably accommodate one end of the rectangular retainer 49, 55.

The lower coupling formation depicted in FIG. 9a, in a difference from the upper coupling formations, also includes a pair of keeps 79 that co-operate with fixings (not shown in this figure) to enable the support to be secured to the base. In the preferred arrangement the keeps 79 comprise internally threaded cylinders that co-operate with bolts or screws to couple the support to the base in a manner that is later described below. FIG. 9b is a schematic perspective view of a co-operating wedge 51, 57. As aforementioned the wedges in the vicinity of either end of the support are identical and hence only one shall now be described, in this case the lower co-operating wedge 51.

The cooperating wedge 51 comprises first and second wedge shaped portions 81, 83 that are coupled to one another by a generally rectangular plate 85 that extends transversely to either inclined side of the wedge shaped portions 81, 83. The wedge shaped portions are, as shown, generally triangular in lateral cross-section, and preferably include inclined faces that have an angle of inclination which is the same as, or at least similar to, the angle of inclination of the aforementioned ramped surfaces 67, 69. A pair of retaining pins 87 (only one of which is visible in FIG. 9b, but both of which are shown extending from the upper wedge 57 in FIG. 8) extend from points in the vicinity of respective ends of the rectangular plate 85, and an aperture 89 for receiving the fixing 53 is provided therebetween.

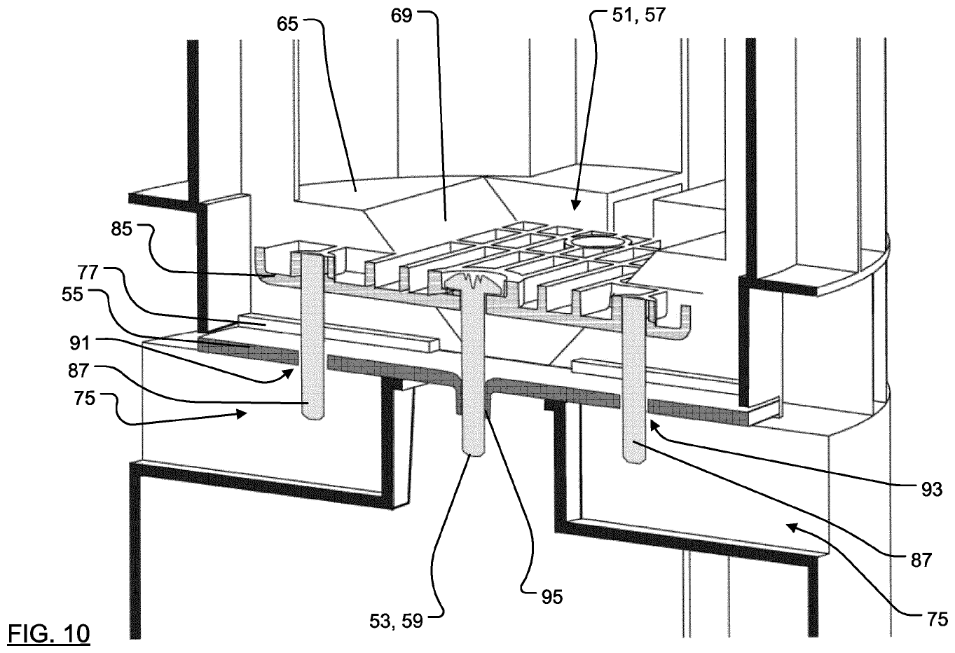

The rectangular retainers 49, 55, as best shown in FIG. 9a, include an aperture 91, 93 provided in the vicinity of respective ends of the retainers, and a threaded bore 95 through the rectangular retainers 49, 55 is provided between the apertures 91, 93. As can best be seen in FIG. 10 (which is a cross-sectional view along the line A-A of FIG. 3 through the upper end of the support), when the retainers 49, 55 and wedges 51, 57 are brought together, the retaining pins 87 of the wedge 51 are arranged so as to align with and extend through the apertures 91, 93 in the rectangular retainer 49, 55; and the threaded bore 95 in the rectangular retainer 49, 55 is arranged to align with the aperture 89 in the rectangular plate 85. As shown in FIG. 10, the pins extend through the retainer and into the slots 75 provided in the lateral walls 73 in the channel 71 between the projections 63, 65. The fixing 53, in this instance a threaded bolt, extends through the aperture 89 in the rectangular plate and engages with the threaded bore 95.

Advantageously, if the fixings 53, 59 should be inadvertently (or intentionally) decoupled from the associated retainers 49, 55 the facts that the pins 87 are received in the associated slots 75 stops the two support members from falling apart.

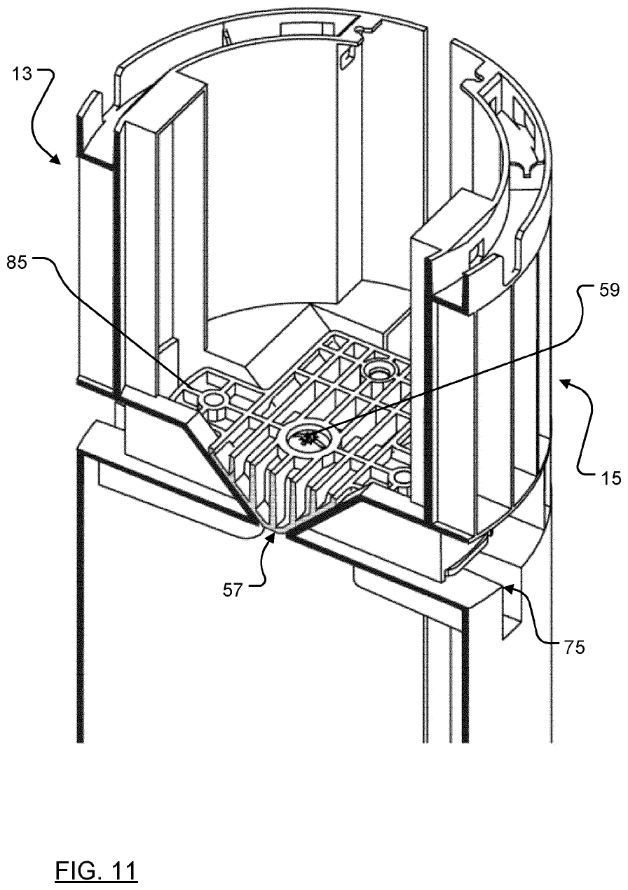

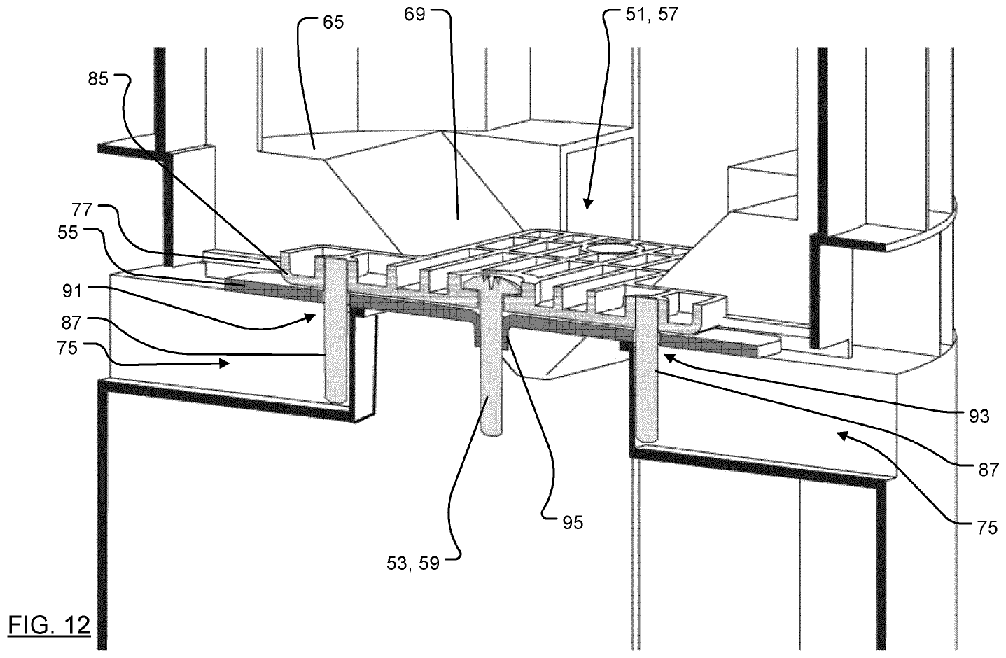

The manner in which the coupling formations operate will now be described with reference to FIGS. 10 to 13 of the accompanying drawings, which figures are cross-sections through the “upper” end of the support (it being remembered, of course, that the lower end of the support is structurally similar and functionally identical). FIG. 10 is a schematic cross-sectional view along the line A-A of FIG. 3, and FIG. 11 is a schematic cross-sectional view along the line B-B of FIG. 3. FIGS. 12 and 13, respectively, show the same cross-sectional views as FIGS. 10 and 11 except that the coupling formations have been operated to drive the two parts of the support apart.

As will be apparent to persons of skill in the art by comparing FIGS. 10 and 11 with FIGS. 12 and 13, as the fixing 59 is screwed into the threaded bore 95 the rectangular plate 85 of the wedge 51 is drawn towards the rectangular retainer 55 (which is retained (relative to the support members) at either end by the ribs 77) and, concomitantly therewith, the wedge shaped portions 81, 83 are drawn across the ramped surfaces 67, 69 of each projection 63, 65 to thereby drive the top portion of the support members 13, 15 from the configuration shown in FIGS. 10 and 11 where the respective support members are relatively close to one another towards the configuration shown in FIGS. 12 and 13 where the support members are spaced from one another. Screwing the fixing 53 of the lower coupling formation into the associated retainer 49 drives the lower portions of the support members apart in a similar manner.

It will be appreciated that by turning the upper and lower fixings 59, 53 a user can cause the support members to apart from one another, and hence move the support as a whole between a configuration where a cover 5 of the type shown in FIG. 2 is loosely supported by the support (and hence can be removed and replaced) to a configuration where a cover is tensioned and supported by the support for use as a scratching post.

Turning the upper and lower fixings 59, 53 in the opposite direction increases the spacing between the wedges and associated retainers, and the support members can be moved closer to one another to relax the cover mounted on the support.

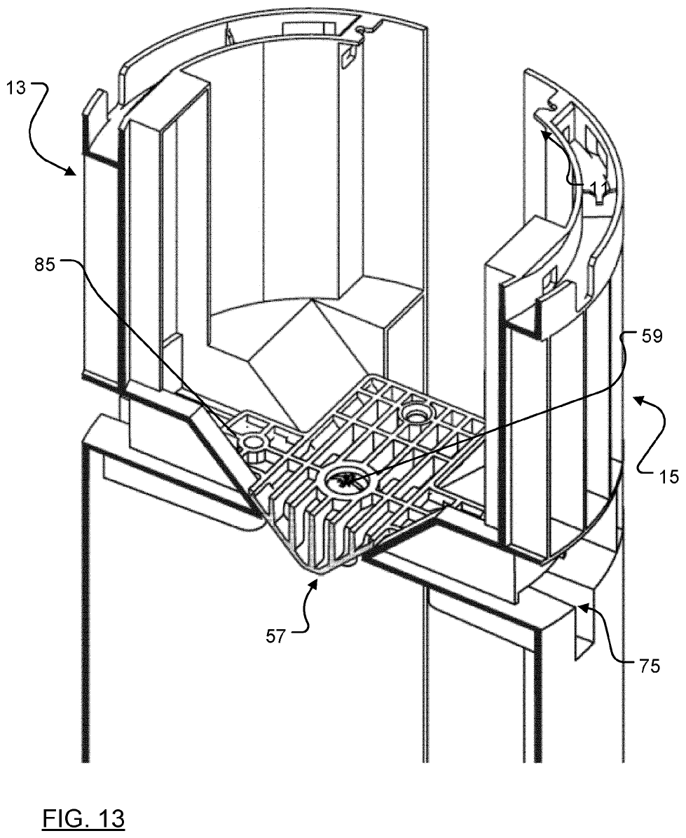

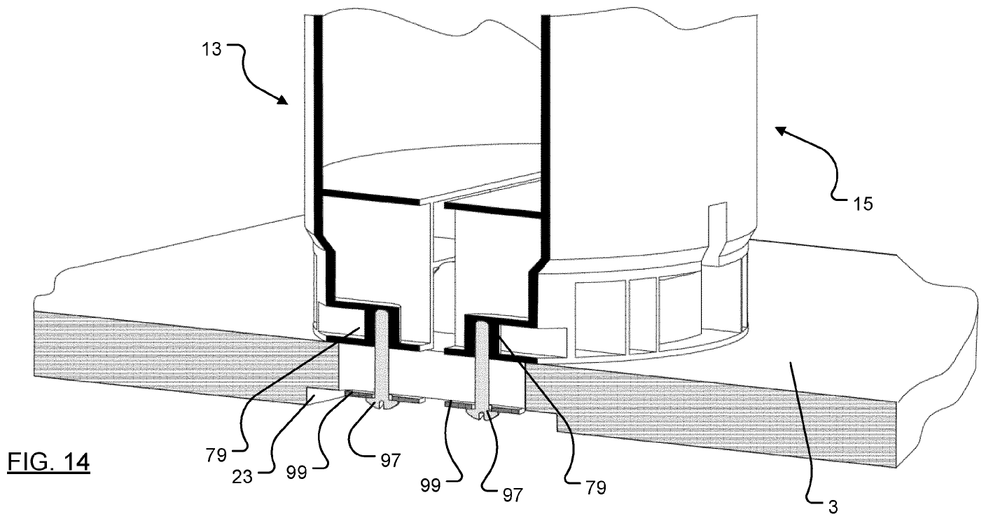

FIGS. 14 and 15 are part cross-sectional views along the line C-C of FIG. 3 depicting the manner in which the lower end of the support is coupled to the base 3 so that, in this embodiment, both support members can move relative thereto when the lower fixing 53 is screwed into the lower rectangular retainer 49 (it being remembered that it is only preferred for both support members to move relative to the base, and that it is envisaged for only one support member to move relative to the base).

As aforementioned, each support member includes a pair of keeps 79, and the support members are configured so that first keeps 79 of each support member (when the members are brought together) align with the first 19 of the two slots in the base and second keeps (not visible) align with the second 21 of the two slots in the base. Fixings 97 extend through washers 99 and each engage with a respective keep to secure the base to respective support members. In the preferred arrangement the fixings 97 amd keeps 79 are configured so that the support members are closely coupled to the base, without being so closely coupled to the base that they cannot slide over the surface of the base without being loosened. In another envisaged arrangement, the fixings and keeps are configured so that the support members cannot move relative to one another without the fixings first being loosened.

Advantageously, since the slots open to a recess 23 in the underside of the base, the heads of the fixings 97 are less likely to scrape across the surface of the floor on which the apparatus sits.

As shown in FIG. 15, when the support members are coupled to the base, the aperture 17 in the base aligns with the fixing 53 that couples the lower wedge 51 to the co-operating generally rectangular retainer 49. By virtue of this arrangement a user can adjust the spacing of the respective support members (by screwing the fixing 53 into or out of the lower rectangular retainer 49) without having to decouple the support members from the base.

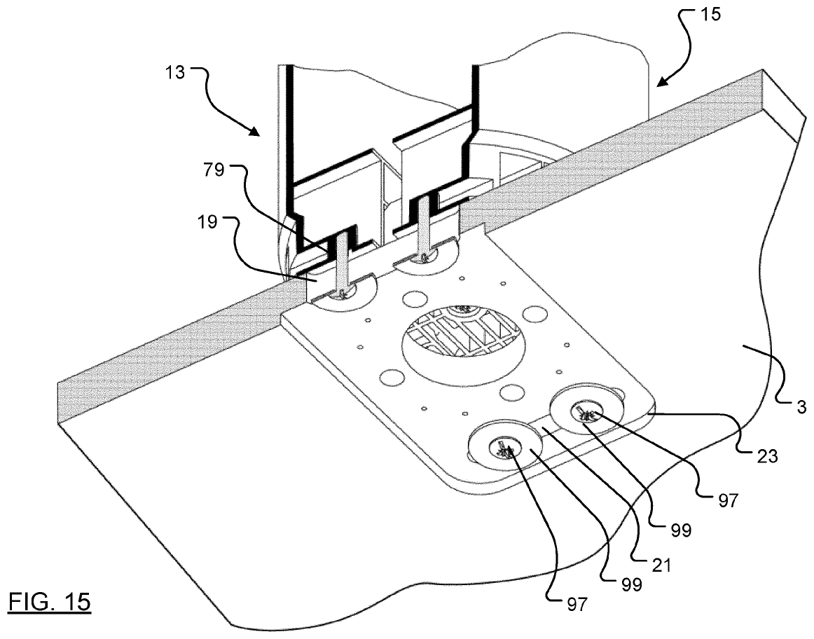

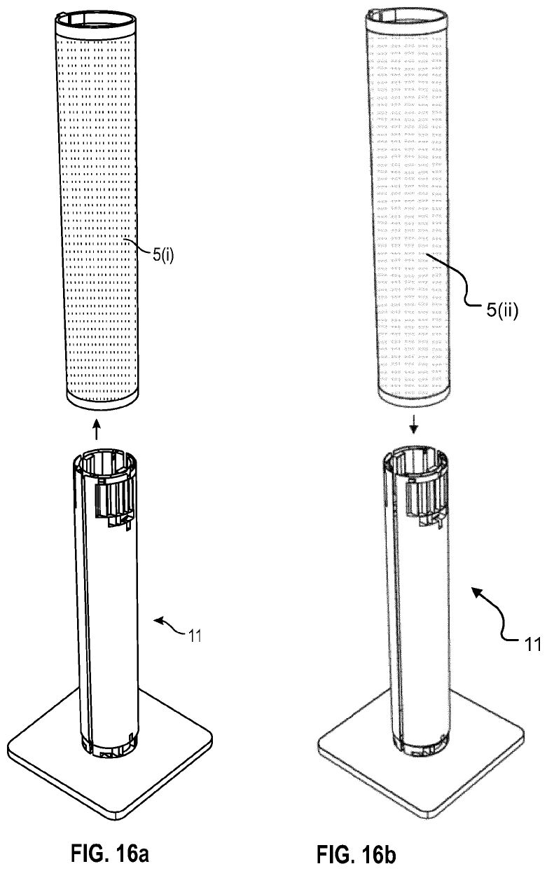

Referring now to FIGS. 16a, 16b and 17, with the support in the position depicted in FIGS. 3 and 10 (i.e. with the upper and lower wedges withdrawn from the associated upper and lower rectangular retainers), a worn cover 5 (i) is only loosely supported by the support 11 and can simply be lifted off the support (as shown in FIG. 16a) once the cap 7 has been removed. A new replacement cover 5 (ii) can then be slid onto the support 11 (as depicted in FIG. 16b) so that the replacement cover 5 (ii) is now loosely supported by the support 11.

Once the replacement cover 5 (ii) has been placed onto the support, a user tightens the fixings 53, 59 (using a screwdriver for example) of the upper and lower coupling formations so that the wedges 51, 57 are drawn towards the associated retainers 49, 55 and the support members 13, 15 are driven outwardly into abutment with an interior surface of the replacement cover 5 (ii). As the support member are so driven, the replacement cover 5 (ii) is tensioned around the support 11 to form an effective scratching apparatus. Once the replacement cover 5 (ii) has been tensioned to an appropriate extent, the cap 7 can be refitted to the support, and if necessary the fixings 97 can be tightened, whereupon the apparatus will be ready to be used.

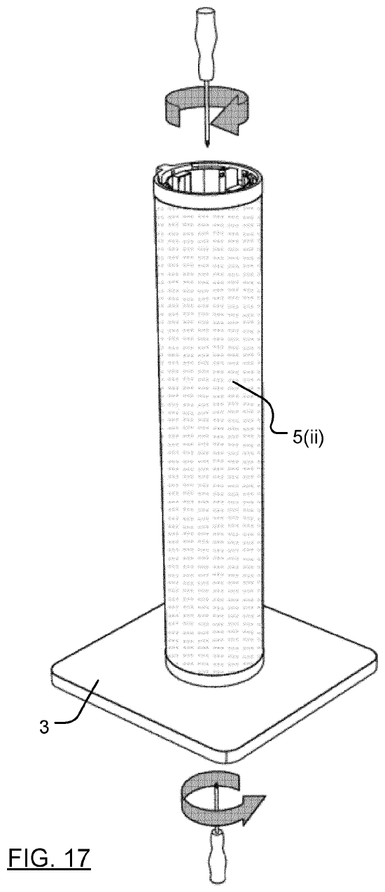

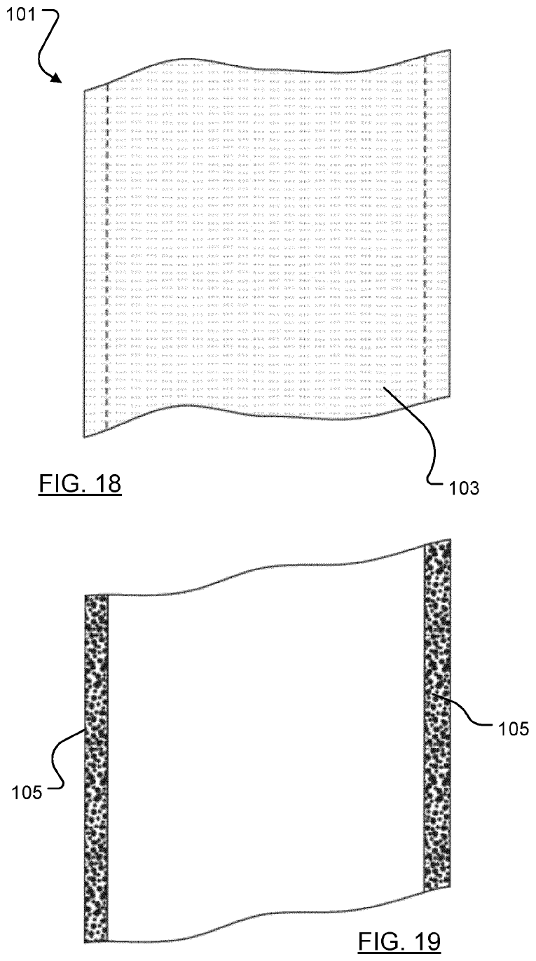

Referring now to FIGS. 18 and 19 of the drawings, there is depicted-respectively—front and rear perspective views of a cover 101 for a second illustrative scratching apparatus. The cover 101 comprises a generally planar panel of material (typically a generally rectangular panel of material) with a scratchable surface 103 that will form the outer surface of the cover in use. The cover may comprise a panel of woven sisal, carpet or any other suitable material against which an animal, such as a feline, can scratch its' claws. The opposing side of the cover 101 includes—in the vicinity of opposing shorter sides of the cover 101—a plurality of instances of one part of a two-part mechanical fastener. For example, the opposing side of the cover 101 may include two strips of mechanical hook and loop fastener 105 (such as Velcro™, for example) affixed—for example, stitched—to the cover 101 at least in the vicinity of opposing shorter sides of the cover 101. In alternative arrangements, other types of two-part fastener, such as press studs, could be employed if desired.

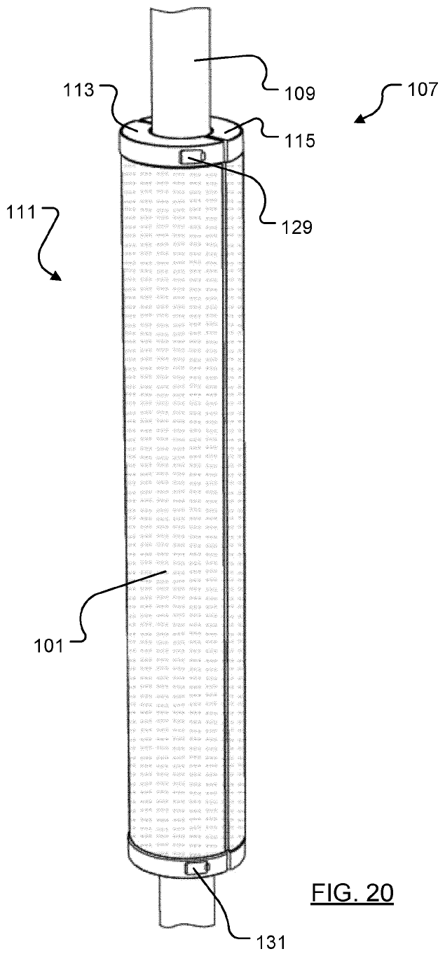

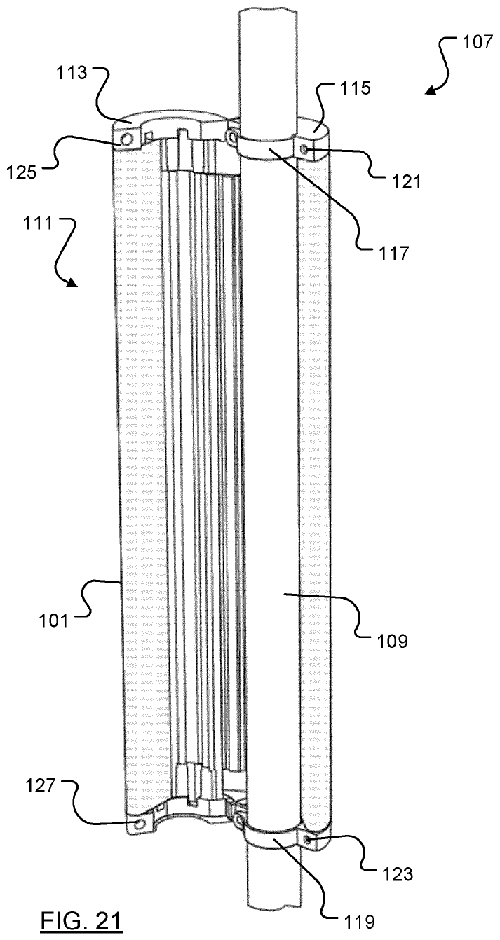

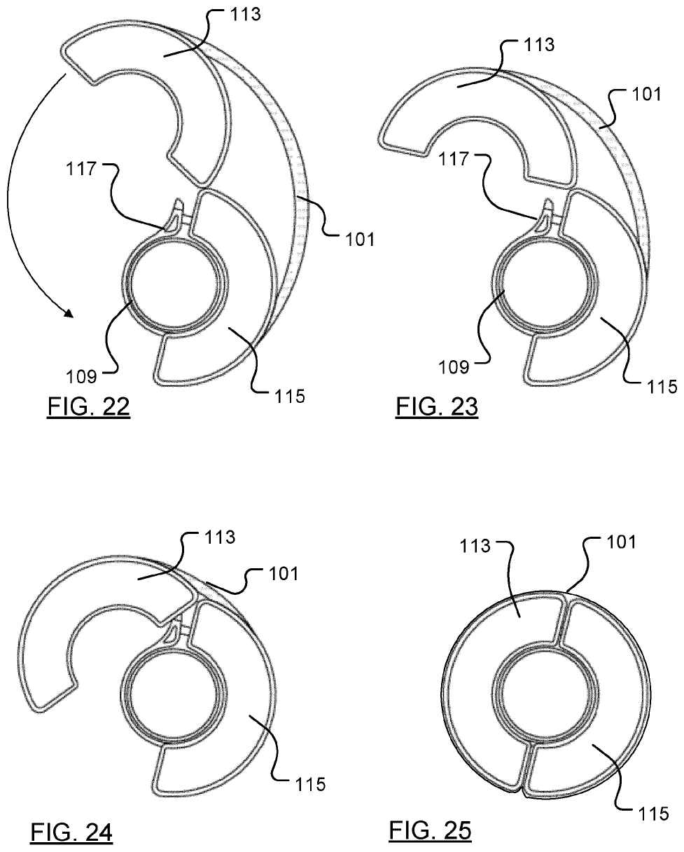

FIG. 20 is a perspective view of the aforementioned second illustrative scratching apparatus 107, and FIG. 21 is a perspective view of the apparatus 107 depicted in FIG. 20 shown partly disassembled.

The scratching apparatus depicted in these figures is shown as being assembled around a pole 109, for example a pole that forms part of a so-called “cat tree” or a chair or table leg. It will be appreciated, however that the pole could be coupled at one end to a base to form scratching apparatus intended to sit on the floor (in a similar manner to the first embodiment).

The apparatus comprises a support 111 to which the aforementioned cover 101 has been fitted. The support 111 is a two-part support comprising first and second support members 113, 115 coupled to one another in a “clamshell” configuration. As will be appreciated, a “clamshell” configuration is one where two components are hingedly coupled to one another along an edge, in a manner similar to a laptop computer for example. The hinge (not visible in the figures), in this arrangement, may comprise a mechanical hinge or a living hinge.

The first and second support members 113, 115 are generally “C” shaped in lateral cross-section, so that the support members-when closed together-define a tubular body in which—in this particular example—the pole 109 can be accommodated. One support member, in this instance the second support member, includes a pair of lateral arms 117, 119 located, respectively, in the vicinity of the top and bottom of the support. The arms are configured to be secured around the pole 109 to securely couple the second support member 115 to the pole 109.

Respective interior portions of the first and second support members distal from the hinge between them are provided with a plurality of instances of the second part of the aforementioned two-part mechanical fastener. For example, the cover may be provided with a strip of loops in the vicinity of either shorter edge, and interior portions of the first and second support members may each be provided with a strip of hooks. In this way, a strip of loops (for example) on the cover at one shorter side may be coupled to a strip of hooks (for example) on the inside of the first support member and the strip of loops (for example) on the cover at the opposite shorter side may be coupled to a strip of hooks (for example) on the inside of the second support member so that the cover 101 extends around the outside of the support to cover the hinge with the scratchable surface outermost.

The second support member 115 includes first and second keeps 121, 123 in the vicinity of the upper and lower ends of the support. The keeps 121, 123 align with channels 125, 127 in the first support member 113 when the clamshell support is closed, and fixings (not shown) can be inserted from outside of the support through the channels and engaged with the keeps to securely couple one support member to the other once the cover has been fitted to the support. In FIG. 20, the first support member includes a pair of removable blanking plates 129, 131 that have been inserted into the channels to obstruct access to the fixings.

An advantage of this particular apparatus is that by choosing the size of the cover and the placing of the associated fasteners on the cover and the support members it is possible to provide scratching apparatus that automatically tensions the cover when the user closes the clamshell without the user having to adjust the apparatus once a used cover has been exchanged for a replacement.

FIG. 22 is a schematic top plan view of the apparatus with the clamshell open and the cover 101 secured to the internal surfaces of the first and second support members 113, 115. As shown, the cover is relatively loosely mounted on the support. As the clamshell is progressively closed by moving the two support members together, so the spacing between the cover 101 and the support members 113, 115 reduces (as shown in FIGS. 23 and 24), until the support members 113, 115 are adjacent one another (i.e. the clamshell is closed) and the cover is tightly wrapped and tensioned around the exterior of the support. In this way a user can effectively tension the cover on the support simply by closing the clamshell.

FIG. 26 is a diagrammatic cross-sectional view of a third illustrative scratching apparatus. The scratching apparatus 133 comprises first and second support members 135, 137 that are coupled together by a coupling formation 138. The coupling formation comprises the following features: one support member, in this instance the first support member 135, includes a tube 139 that extends from an internal surface of the support member. A resilient bias, for example a helical spring 141, is provided within the tube. A plunger 143 extends from an internal surface of the second support member 143 and is moveable into the tube 139 against the resilient bias. The plunger 143 includes a circumferential lip in the vicinity of an end of the plunger distal from the second support member and the tube 139 is narrowed in the vicinity of an end of the tube 139 distal from the first support member, the arrangement being such that the plunger is restrained from being removed from the tube.

In this arrangement the support members can be brought together against the action of the resilient bias (for example by pushing them together), and a tubular scratchable cover (not shown)—for example of the type shown in FIG. 2—can be slid onto the support. Once the scratchable cover is in place, the resilient bias acts to drive the support members apart and hence tensions the cover on the support. It is anticipated that so long as the force exerted by the resilient bias is larger than the force that might be exerted on the cover by a cat, for example, scratching against it; then the resilient bias will continue to tension the cover around the support members whilst the apparatus is in use.

It is envisaged that one or more coupling formations may be provided to couple the first and second support members together. For example, one coupling formation may be provided in the vicinity of either end of the support members.

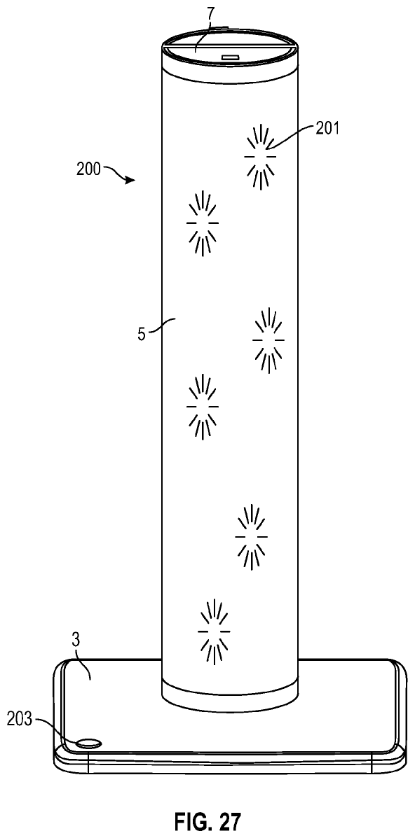

Referring now to FIG. 27, there is depicted a schematic representation of a version of the aforementioned first illustrative scratching apparatus, configured to include a plurality of lights.

Of particular note, at this juncture, is that whilst the lighting arrangement described below is well suited for use with the above-described first illustrative scratching apparatus, the lighting arrangement is not limited only to use with this first illustrative scratching apparatus. As will be appreciated by persons skilled in the art, the lighting arrangement described below could be used with suitably modified versions of the second and third illustrative scratching apparatus described above, or indeed with a conventional scratching post that cannot be configured to tension a scratchable cover around a support.

The above notwithstanding, the combination of the lighting arrangement disclosed below with scratching apparatus that is configurable to tension a scratchable cover (such as a sisal mat, for example) around a support is advantageous, as the tensioning of the cover stretches the cover and increases the size of holes in the cover, thereby allowing more light to penetrate through the cover.

The scratching apparatus 200 depicted in FIG. 27 comprises a base 3 from which a support (not visible) is upstanding. A scratchable cover 5 is received over the support, and—in this particular arrangement—the support has been arranged to tension the cover. The uppermost end of the scratching apparatus in use has been closed by two-part cap of the type described herein.

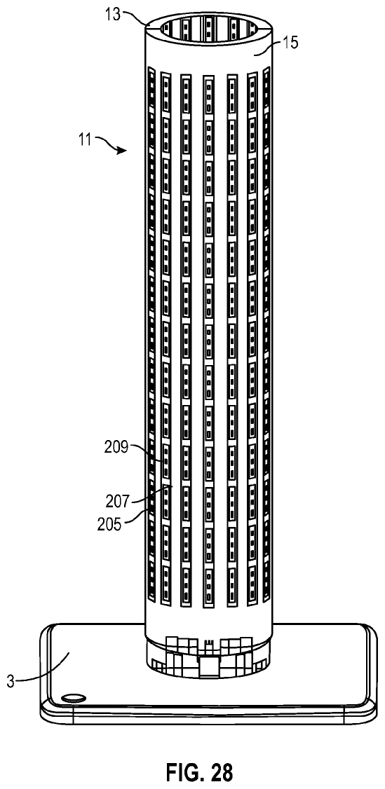

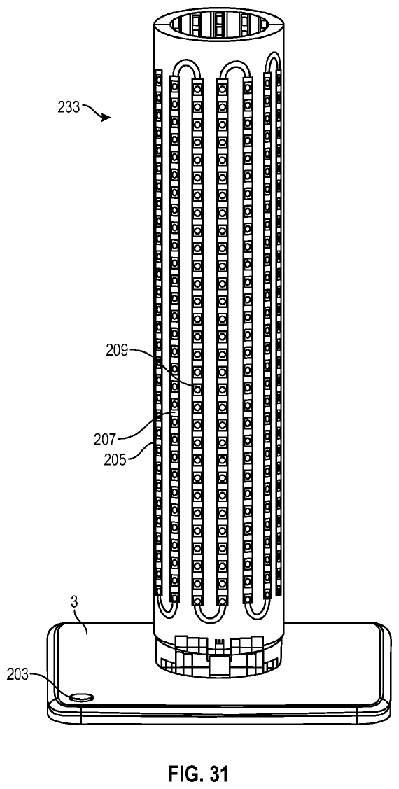

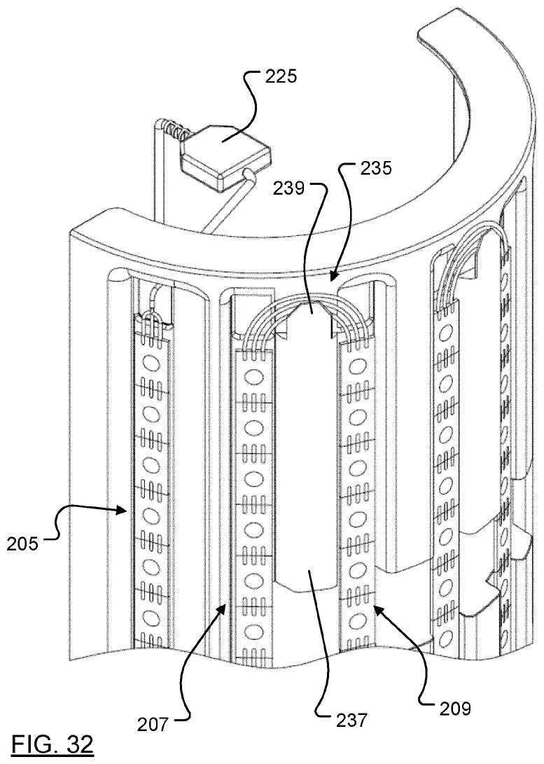

A plurality of lights 201 are provided beneath the cover 5 and are controllable by a user to emit light that shines through the cover. In the arrangement depicted a plurality of lights are shown illuminated at the same time, but as will later be described it is envisaged that each light (or group of lights) is addressable by a controller so that one or more lights can be illuminated at any one time. In this particular arrangement, a button 203 is provided on the base to enable the user to cycle between an “off” state (where no lights are illuminated) and a number of different operating modes by repeatedly pressing the button. FIG. 28 is a schematic representation of the scratching post 200 shown in FIG. 27 with the cover 5 removed. As before, the support 11 comprises first and second support members 13, 15 that are each generally semi-circular in cross-section. In this instance, a plurality of lighting strips 205, 207, 209 etc have been affixed to the outer face of each support member so that light from the strips can shine through the cover when the strips are energised and the cover is mounted on the support. In this particular example the lighting strips are arranged in parallel (in an electrical sense). In another envisaged arrangement (described later below in conjunction with FIGS. 31 and 32), the lighting strips are arranged in series.

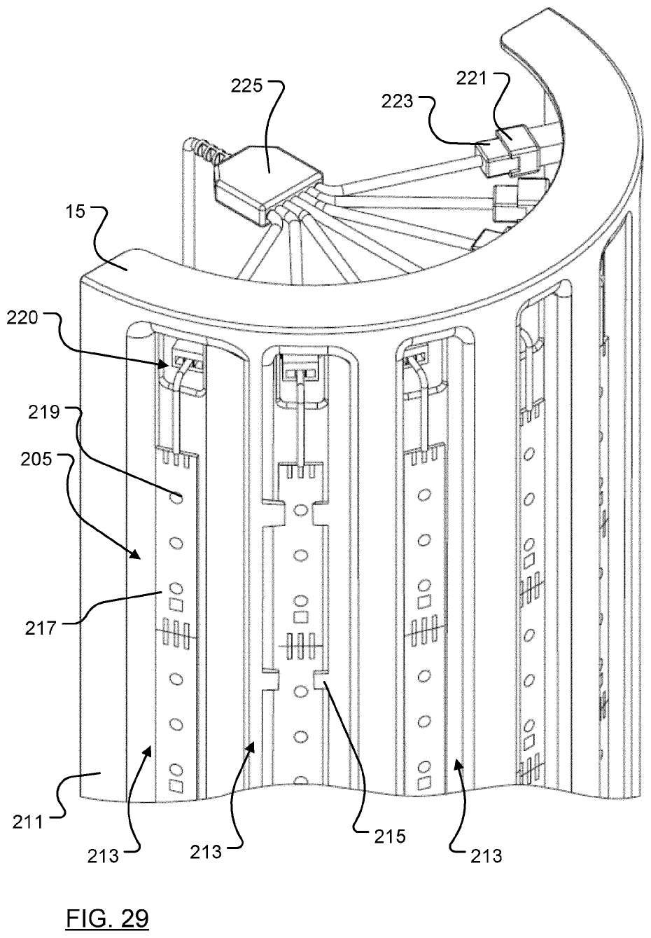

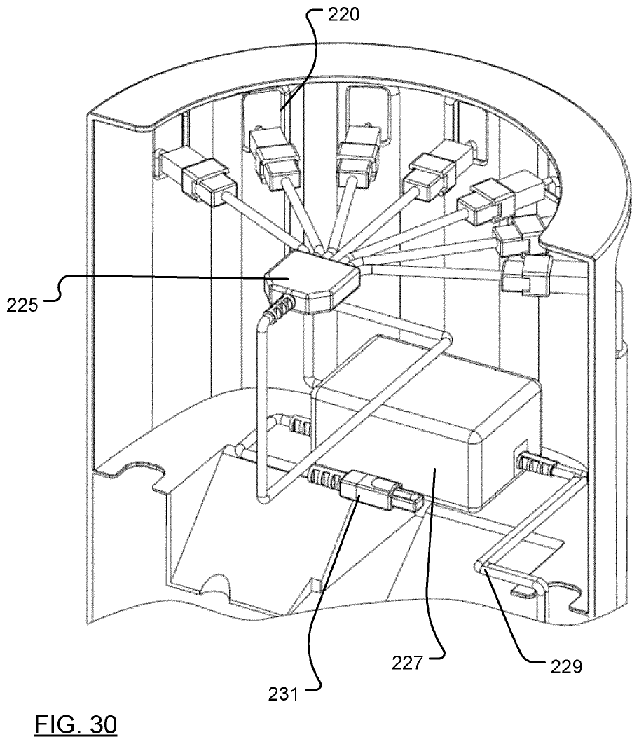

FIGS. 29 and 30 are front and rear views of part (a part that will be uppermost in use) of one of the support members 15 of the scratching post of FIG. 27. As shown in FIG. 29, the outer face 211 of the support member 15 is provided with a plurality of recesses 213, in each of which a lighting strip 205, 207, 209 etc. is located. In an envisaged implementation (shown, for illustration purposes only, for one said recess), the walls that define the recess may include a plurality of tabs 215 that function to retain the strip in the recess. In other envisaged arrangements the strips could be adhered or otherwise affixed to the support member 15. Each recess includes an access aperture 220 opening to the interior of the support member 15.

In this example, the recesses extend generally in parallel to the longitudinal axis of the support 11. Advantageously, as the lighting strips are recessed within the outer face of the support member, the likelihood of the strips being damaged as the cover is put on or taken off is reduced. In an envisaged arrangement, the recesses could be provided with a mirrored finish to increase the amount of light directed towards the cover.

The lighting strips comprise, in this implementation, a plurality of modules 217 joined end-to-end, and each module includes one or more lights 219, for example light emitting diodes. The lighting strips may be configured so that each light can be separately illuminated, or so that individual modules can be illuminated. In the preferred arrangement a plurality of lights and/or modules can be illuminated at any one time.

Each lighting strip is coupled by a wire to a first part 221 of a two-part connector, and the second part 223 of the connector is coupled by a wire to a distribution node 225 that is coupled to a controller 227. The controller, and distribution node are hidden within the interior of the support. In preferred arrangement, the two-part connector can be decoupled so that malfunctioning lighting strips can be replaced.

In this implementation, the controller 227 is coupled to the button 203 by means of a cable 229. In other envisaged arrangements, the controller may be controllable with a remote commander that can wirelessly communicate with a transceiver in the controller. The controller could be controlled by an app running on a mobile computing device. The controller 227 includes a second output cable 231 for connection to a second distribution node (not shown) and associated lighting strips located in the other support member 13. In another implementation, this second cable 231 can be omitted if the other support member is not provided with any lighting strips.

Power may be supplied to the controller from a battery provided within the controller, which battery is preferably rechargeable, or via a cable (not shown) coupled to the mains.

The controller is configured so that the lights can be illuminated in a variety of patterns. For example, the controller could be configured to illuminate lighting strips in sequence so that strips of light move around the scratching apparatus, or to illuminate rings of lights in sequence so that rings of light move up and down the apparatus. Alternatively, or additionally, the controller could illuminate lights or modules of strips in a sequence so that illuminated regions move round and/or up and down the scratching apparatus to give a cat something to chase round the apparatus. In a preferred implementation, a user may be able to vary the speed at which the illuminated regions move around the scratching apparatus. The controller could also be configured to turn on all the lights, or to illuminate lights in a random pattern. A variety of other arrangements will be apparent to persons of skill in the art.

FIG. 31 is a schematic representation of another implementation of the scratching post 233 shown in FIG. 27 with the cover removed. In this instance, the lighting strips are connected in series to the distribution node 225. As shown in FIG. 32, the lighting strips are coupled to adjacent strips by wires 235, and as a result the orientation of said said strip relative to another can easily be adjusted. A retaining clip 237 that is generally C-shaped in lateral cross-section may be frictionally retained in adjacent recesses. The clip 237 includes a tab 239 that lies over the wires 235 and protects the wires as the cover 5 is put onto and taken off the support.

In this implementation the recesses again extend generally in parallel to the longitudinal axis of the support 11. In another envisaged arrangement, a single spiral recess could be provided into which a continuous length of lighting strip could be fitted.

It will be apparent from the foregoing that the arrangement described provides several advantages over previously proposed arrangements. For example, as the lighting strips are recessed into the outer surface of the support member, the likelihood of those lighting strips being damaged during replacement of the cover is reduced. In addition, as the lighting strips lie directly under the cover when the cover is installed on the support, more of the light emitted by the strips is able to pass through the cover.

It is also envisaged for the lighting strips, controller and distribution node to be sold as a kit for retrofitting a lighting arrangement to existing scratching apparatus that has a removable scratchable cover.

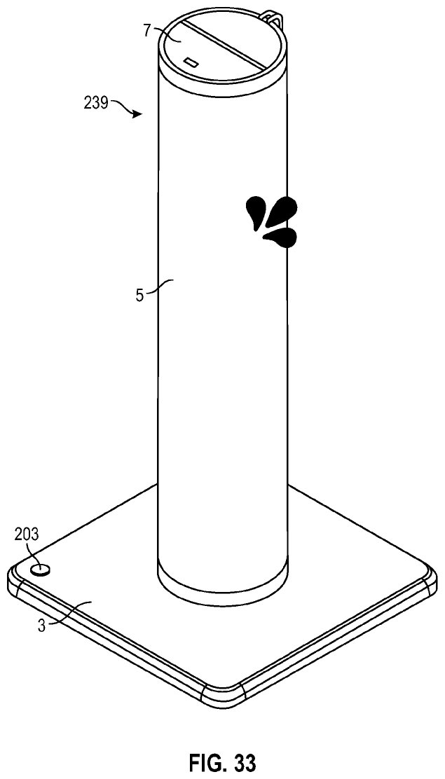

Referring now to FIG. 33, there is depicted a schematic representation of a version of the aforementioned first illustrative scratching apparatus 239, configured to include a dispenser for catnip (for example) which can be controlled to spray a quantity of catnip through the cover 5.

Of particular note, at this juncture, is that whilst the dispenser arrangement described below is well suited for use with the above-described first illustrative scratching apparatus, the dispenser arrangement is not limited only to use with this first illustrative scratching apparatus. As will be appreciated by persons skilled in the art, the dispenser arrangement described below could be used with suitably modified versions of the second and third illustrative scratching apparatus described above, or indeed with a conventional scratching post that cannot be configured to tension a scratchable cover around a support.

The above notwithstanding, the combination of the dispenser arrangement disclosed below with scratching apparatus that is configurable to tension a scratchable cover (such as a sisal mat, for example) around a support is advantageous, as the tensioning of the cover stretches the cover to increase the size of holes in the cover, thereby facilitating the spray of catnip (or other fluid) through the cover.

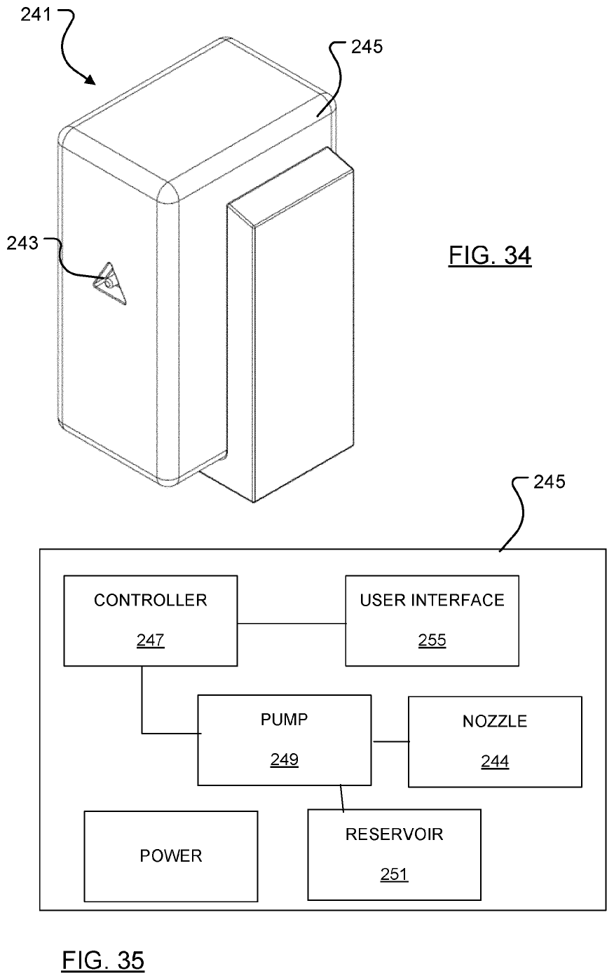

FIG. 34 is a perspective view of a dispenser 241. In this instance the dispenser is electrically operated and includes a nozzle 243 through which a measure of fluid, such as catnip, can be dispensed. The dispenser has a housing 245 within which the functional components shown in FIG. 35 are located. The dispenser may be configured to be coupled to the mains, or could be battery operated. Electrically operated spray dispensers of this type are well known in the art. The dispenser is located within the support 11 and configured to dispense liquid through the cover 5 when the cover is fitted over the support 11.

Referring now to FIG. 35, the dispenser 241 includes a controller 247 that is coupled to a pump 249. The pump is controllable by the controller 247 to draw a measure of liquid (for example, liquid catnip) from a reservoir 251 that is preferably refillable by a user. Once the pump has withdrawn a measure of liquid from the reservoir it is operable to pump that measure of liquid through the nozzle 243 to dispense the liquid. Preferably the nozzle 243 is a spray nozzle that is operable to generate a mist of fluid for passage through the cover 5. A power source 253, such as a battery, is provided to power the dispenser, and a user interface 255 is coupled to the controller to allow a user to operate the dispenser.

The user interface could comprise a button (such as a button 203 on the base 3), which when depressed, signals the controller to operate the dispenser to dispense fluid, such as liquid catnip. In another envisaged implementation, the user interface may include a wireless transceiver so that a user can communicate wirelessly with the controller to control the dispenser.

It is also envisaged for the user to be able to control other aspects of the dispenser. For example, the user could program the dispenser to dispense liquid catnip at predetermined times of the day, or days of the week. The user may also be able to vary the amount of fluid drawn by the pump from the reservoir for dispense. The dispenser could be controlled by an app running on a mobile computing device, or by means of a remote commander.

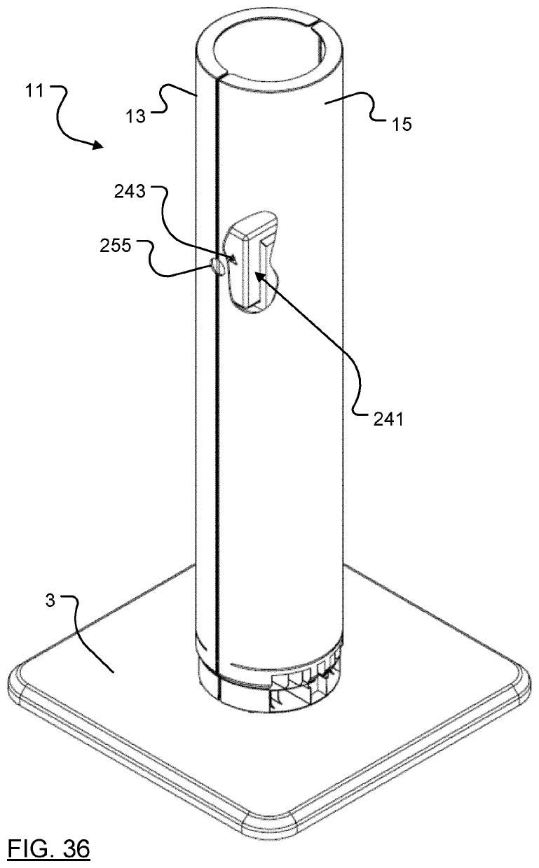

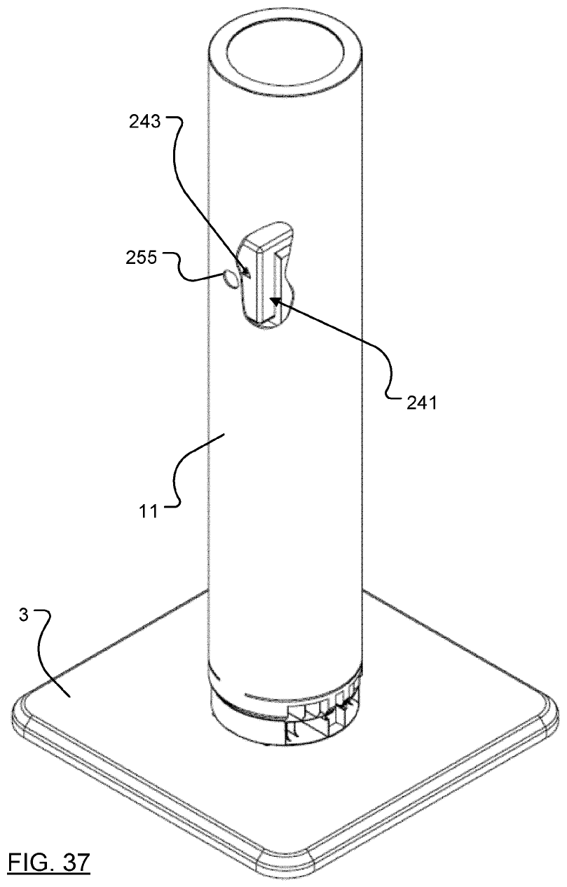

FIG. 36 is a schematic representation of the scratching apparatus 239 shown in FIG. 33 with the cover removed, partly cut-away to show the dispenser 241. As shown, the dispenser 241 is housed within the support 11 formed by the first and second support members 13, 15 so that the nozzle 243 is generally adjacent an aperture 255 in the support; and can dispense liquid through the aperture and any cover provided on the support. FIG. 37 is a schematic representation of another scratching apparatus with the scratchable cover removed, partly cut-away to show the dispenser. In this instance, the apparatus is not capable of tensioning a cover around the support, but is nonetheless operable to dispense a measure of fluid through the aperture 255 and any cover mounted thereon.

As will no doubt be appreciated from the foregoing, this arrangement is advantageous in this it allows users to reward their pets with a measure of catnip, for example, which clears in a relatively short period of time. As a result, the likelihood of a cat becoming used to catnip and uninterested in it, is reduced.

It will be appreciated that whilst various aspects and embodiments of the present disclosure have heretofore been described, the scope of the present disclosure is not limited to the particular arrangements set out herein and instead extends to encompass all arrangements, equivalents, modifications and alterations thereto, which fall within the spirit and scope of the invention. For example, whilst in the first embodiment described above it is the case that both support members can move relative to the base, it will be apparent to persons skilled in the art that this arrangement is not essential. Rather, it is possible for one support member to be fixed to the base and the other to move relative to the base.

It is also the case that the controller of the dispenser may be the same as the lighting controller, that is to say that a single controller may function both as a dispenser controller and a lighting controller.

It should also be noted that whilst particular combinations of features have been described herein, the scope of the present disclosure is not limited to the particular combinations mentioned herein, but instead extends to encompass any combination of features herein disclosed.

In particular, it should be noted that the scope of the present disclosure includes a lighting arrangement of the type described above in combination with conventional scratching apparatus; a lighting arrangement of the type described above in combination with scratching apparatus of the type described herein (namely, apparatus operable to tension a scratchable cover); a dispenser for catnip of the type described above in combination with conventional scratching apparatus; a dispenser for catnip of the type described above in combination with scratching apparatus of the type described herein (namely, apparatus operable to tension a scratchable cover); a lighting arrangement and a catnip dispenser, each of the type described above, in combination with conventional scratching apparatus; and a lighting arrangement and a catnip dispenser, each of the type described above, in combination with scratching apparatus of the type described herein (namely, apparatus configured to tension a scratchable cover).

Finally, it should be noted that any element in a claim that does not explicitly state “means for” performing a specified function, or “steps for” performing a specific function, is not to be interpreted as a “means” or “step” clause as specified in 35 U.S.C. Sec. 112, par. 6. In particular, the use of “step of” in the claims appended hereto is not intended to invoke the provisions of 35 U.S.C. Sec. 112, par. 6.

Certain illustrative aspects of scratching apparatus disclosed herein are set out in the following numbered paragraphs:

1. Scratching apparatus comprising a support for a scratchable cover, wherein the support comprises a plurality of support members, the support being reconfigurable between first and second states, wherein in said first state a scratchable cover supported by said support is loosely mounted on said support and in said second state said scratchable cover is tensioned around the support, the arrangement being such that reconfiguring said support from said first state to said second state causes at least one of said support members to move relative to another support member to tension the scratchable cover around the support, and reconfiguring said support from said second state to said first state causes at least one of said support members to move relative to another support member to loosen the scratchable cover mounted on the support.

2. Scratching apparatus according to Paragraph 1, wherein reconfiguring said support from said first state to said second state causes at least one of said support members to move relative to another support member to increase the spacing between the support members and thereby tension the scratchable cover on the support.

3. Scratching apparatus according to Paragraph 1 or 2, wherein reconfiguring said support from said second state to said first state causes at least one of said support members to move relative to another support member to reduce the spacing between the support members and thereby relax the scratchable cover mounted on the support.

4. Scratching apparatus according to any of Paragraphs 1 to 3, comprising a base, said support being coupled to said base.

5. Scratching apparatus according to Paragraph 4, wherein said support comprises a first support member and a second support member.

6. Scratching apparatus according to Paragraph 5, wherein said support is coupled to said base in such a way that said first and second support members can both move relative to said base.

7. Scratching apparatus according to Paragraph 5 or 6, comprising at least one coupling formation for coupling said first support member to said second support member.

8. Scratching apparatus according to Paragraph 7, wherein said coupling formation is operable to drive the support members apart.

9. Scratching apparatus according to Paragraph 8, wherein said coupling formation includes a wedge for driving the support members apart.

10. Scratching apparatus according to Paragraph 9, wherein said wedge is coupled to a retainer in such a way that movement of the wedge away from the retainer enables the support members to be moved closer to one another.

11. Scratching apparatus according to Paragraph 1, wherein the support comprises first and second support members coupled together in a clamshell arrangement.

12. Scratching apparatus according to Paragraph 11, wherein reconfiguring the support from said first state to said second state causes a distance between said first and second support members to reduce.

13. Scratching apparatus according to Paragraph 11 or 12, wherein reconfiguring the support from said second state to said first state causes a distance between said first and second support members to increase.

14. Scratching apparatus according to any of Paragraphs 11 to 13, wherein one of said first and second support members is configured to be coupled to a rod or pole.

15. Scratching apparatus according to Paragraph 14, wherein said rod or pole comprises a limb of a cat tree.

16. Scratching apparatus according to Paragraph 14, wherein said rod or pole is coupled to a base.

17. Scratching apparatus according to any of Paragraphs 11 to 16, wherein said scratchable cover comprises a panel having first and second faces, said first face comprising a scratchable surface, said second face including first and second couplings connectable, respectively, to said first and second support members to couple the cover to the support.

18. A scratchable cover configured and arranged for use with scratching apparatus according to any preceding paragraph.

19. A scratchable cover according to Paragraph 18, wherein said cover is of sisal or carpet material.

20. A scratchable cover according to Paragraph 18 or 19 when dependent of any of Paragraphs to 1 to 11, wherein said cover is generally tubular.

1-27. (canceled)

28. Scratching apparatus comprising a support for a scratchable cover, the support defining an internal cavity and having an outer face against which said cover lies when the cover is mounted on the support, said outer face having a recess formed therein in which a plurality of lights is provided, the lights being coupled to a lighting controller provided in said internal cavity, said controller being operable to illuminate one or more of said lights.

29. Scratching apparatus according to claim 28, wherein the outer face includes a plurality of spaced recesses extending generally in parallel with a longitudinal axis of said support, each recess having a plurality of lights provided therein.

30. Scratching apparatus according to claim 29, wherein said plurality of lights are arranged in strips, said strips being affixed to the outer face of said support so that light from the strips can shine through the cover when the cover is received on the support.

31. Scratching apparatus according to claim 30, wherein the lighting strips comprise a plurality of modules joined end-to-end, each module including one or more lights.

32. Scratching apparatus according to claim 29, wherein one or more of said recesses is provided with a mirrored finish to increase the amount of light directed towards the cover.

33. Scratching apparatus according to claim 29, wherein the support comprises a plurality of tabs in the vicinity of each recess that function to retain the strips in the recesses.

34. Scratching apparatus according to claim 29, wherein each recess includes an access aperture opening to the interior of the support.

35. Scratching apparatus according to claim 29, further comprising a distribution node that is coupled to said controller.

36. Scratching apparatus according to claim 35, wherein the controller and distribution node are hidden within the interior of the support.

37. Scratching apparatus according to claim 35, wherein said lighting strips are electrically connectable in parallel or in series to said distribution node.

38. Scratching apparatus according to claim 36, wherein the lighting strips are electrically connectable in series to the distribution node and coupled to adjacent strips by wires.

39. Scratching apparatus according to claim 38, further comprising a retaining clip that is generally C-shaped in lateral cross-section and may be frictionally retained in a said recess, the clip including a tab that lies over the wires to protect the wires as a cover is put onto and taken off the support.

40. Scratching apparatus according to claim 38, wherein said lighting strips and connecting wires form a serpentine structure.

41. Scratching apparatus according to claim 28, wherein said lights are configured so each light can be separately illuminated, and/or so that groups of lights can be separately illuminated.

42. Scratching apparatus according to claim 28, comprising a user interface that allows a user to instruct the controller to control the lights.

43. Scratching apparatus according to claim 42, wherein the user interface comprises a button that a user can press to control the controller.

44. Scratching apparatus according to claim 42, the controller is controllable with a remote commander that can wirelessly communicate with a transceiver in the controller.

45. Scratching apparatus according to claim 42, wherein the controller comprises a wireless transceiver and is controlled by means of an app on a mobile computing device.

46. Scratching apparatus according to any preceding claim, wherein the support comprises a plurality of support members, the support being reconfigurable between first and second states, wherein in said first state a scratchable cover supported by said support is loosely mounted on said support and in said second state said scratchable cover is tensioned around the support, the arrangement being such that reconfiguring said support from said first state to said second state causes at least one of said support members to move relative to another support member to tension the scratchable cover around the support, and reconfiguring said support from said second state to said first state causes at least one of said support members to move relative to another support member to loosen the scratchable cover mounted on the support.

47. Scratching apparatus comprising support means for a scratchable cover means, said support means defining an internal cavity and having an outer face against which said cover means lies when the cover is mounted on said support means, said outer face including a plurality of spaced recesses extending generally in parallel with a longitudinal axis of said support means, each said recess having a plurality of lights provided therein, wherein said plurality of lights are arranged in strips, said strips being provided in the recesses in the outer face of said support means so that light from the strips can shine through the cover when the cover is received on the support means, said lights being coupled to a lighting control means provided in said internal cavity, said lighting control means being operable to illuminate one or more of said lights.
